(19) United States
(12) Patent Application Publication
(10) Pub. No.: US 2020/0363837 A1
(43) Pub. Date: Nov. 19, 2020

(54) PENHOLDER FOR MOBILE DEVICE AND MOBILE DEVICE CASE WITH SAME APPLIED THERETO

(71) Applicant: Seungkyu PARK, Seoul (KR)

(72) Inventor: Seungkyu PARK, Seoul (KR)

(21) Appl. No.: 16/959,965

(22) PCT Filed: Jan. 3, 2019
(86) PCT No.: PCT/KR2019/000071

§ 371 Date: Jul. 2, 2020

(30) Foreign Application Priority Data
Jan. 5, 2018 (KR) 10-2018-0001491

(51) Int. Cl. G06F 1/16; B43K 23/00

(52) U.S. Cl. CPC G06F 1/1607; G06F 2200/1632; B43K 23/00

(57) ABSTRACT

The present invention relates to a penholder for a mobile device and a mobile device case with the same applied thereto. The penholder for a mobile device comprises: a fixed part which is fixed at a position spaced a certain distance inward from an edge of a mobile device; an extending part which extends from a side of the fixed part facing toward the edge of the mobile device to beyond the edge of the mobile device and is foldable on the basis of the fixed part; and a holding part which is coupled to the opposite side of the fixed part at the extending part and into which a touch pen is inserted. Accordingly, it is possible to prevent the penholder for the mobile device from interfering with the use of the mobile device.

### TECHNICAL FIELD

The present invention relates to a penholder for a mobile device and a mobile device case to which the penholder is applied, and more particularly, to a penholder for a mobile device, which does not inhibit the use of a mobile device case, and a mobile device case to which the penholder is applied.

### BACKGROUND ART

Recently, mobile devices such as smartphones and tablet PCs are commonly used. The mobile devices are becoming slimmer for portability, and accordingly, the risk of breakage due to an impact and the like is increasing. A mobile device case is one of devices for reducing the risk of breakage of the mobile device. In particular, a case of the tablet PC includes a body configured to surround an edge portion of the mobile device, and a cover coupled to one side of the body so as to be foldable with respect to the body and configured to cover a display part of the mobile device. The body may protect rear and side surfaces of the mobile device, and the mobile device may be fitted to the body so that the case may be securely coupled to the mobile device. In addition to protecting a display provided on a front surface of the mobile device, the cover may be folded multiple times to have a three-dimensional shape when the mobile device is used so as to allow the mobile device to stand at a predetermined angle.

Meanwhile, a touch pen may be used to operate the mobile device, and the case may be provided with a penholder to which the touch pen is fixedly fitted. However, the penholder, especially the penholder to which the touch pen is fitted, may interfere with an operation of allowing the mobile device to stand by using the cover.

### DETAILED DESCRIPTION OF THE INVENTION

### Technical Problem

Accordingly, in order to solve the above conventional problems, an object of the present invention is to provide a penholder for a mobile device, which may be prevented from interfering with the use of the mobile device, and a mobile device case to which the penholder is applied.

In addition, an object of the present invention is to provide a penholder for a mobile device, in which a touch pen may be easily fitted to or separated from the penholder, and a mobile device case to which the penholder is applied.

### Technical Solution

In order to achieve the above objects, according to the present invention, there is provided a penholder for a mobile device, in which a touch pen is inserted into the penholder, the penholder including: a fixed part fixed at a position spaced inward from an edge of the mobile device by a predetermined distance; an extending part extending from a side of the fixed part, which faces toward the edge of the mobile device, beyond the edge of the mobile device, and foldable with respect to the fixed part; and a holding part coupled to the extending part on an opposite side of the fixed part, and into which the touch pen is inserted.

The extending part preferably includes a first magnet.

The first magnet is preferably disposed in the extending part at a position overlapping the mobile device.

A plurality of first magnets are preferably arranged in a direction parallel to the edge of the mobile device.

The extending part preferably includes: a soft part disposed in the extending part while being adjacent to the fixed part, and having flexibility; and a hard part disposed in the extending part while being adjacent to the holding part, and having rigidity.

The extending part may be formed of a flexible material, and a hard member having rigidity may be attached to the hard part.

The extending part may include a double layer formed of a flexible material, and a hard member having rigidity may be embedded in the hard part.

The hard part preferably includes a first magnet.

The holding part may have a tube shape having a space into which the touch pen is inserted.

The holding part preferably has a slit formed by removing a portion of a wall of the holding part in at least one of both longitudinal ends of the holding part. The holding part is preferably foldable with respect to the extending part.

The fixed part, the extending part, and the holding part may be integrally formed of a flexible material.

According to another embodiment of the present invention, there is provided a mobile device case including: a body fixed to an edge portion of a mobile device; and a cover coupled to one side of the body so as to be foldable with respect to the body, wherein the penholder for the mobile device is fixed to a surface of the mobile device case.

The penholder for the mobile device is preferably fixed to the cover.

### Advantageous Effects of the Invention

According to the penholder for the mobile device of the present invention, the penholder for the mobile device does not interfere with the mobile device or the body or the cover of the mobile device case when the mobile device is used, so that usability of the mobile device can be prevented from being inhibited by the penholder for the mobile device.

The touch pen can be easily fitted to or separated from the penholder for the mobile device.

The penholder for the mobile device can be manufactured very easily by using a member formed of a flexible material.

### DESCRIPTION OF THE DRAWINGS

FIG. 1 is a perspective view showing a penholder for a mobile device according to the present invention.

FIG. 2 is a sectional view showing the penholder for the mobile device.

FIGS. 3 and 4 are views showing use states of the mobile device and a mobile device case to which the penholder for the mobile device is applied.

FIG. 5 is a view for describing a case where the penholder for the mobile device further includes a second magnet or a metal piece.

FIG. 6 is a sectional view showing a penholder for a mobile device according to another embodiment.

### DESCRIPTION OF REFERENCE NUMERALS

1: Penholder for Mobile Device
2: Body 3: Cover
10: Fixed part 11: Second magnet
20: Extending part 21: First magnet
22: Soft part 23: Hard part
23a: Hard member 30: Holding part
31: Slit

### BEST MODE

Hereinafter, a specific embodiment of the present invention will be described in detail with reference to the drawings.

The present invention relates to a penholder for a mobile device, and the penholder may be fixed to a rear surface of the mobile device or may be fixed to a mobile device case. The mobile device case to which the penholder for the mobile device is applied may include a body 2 configured to surround an edge portion of the mobile device, and a cover 3 coupled to one side of the body so as to be foldable with respect to the body and configured to cover a display part of the mobile device, or may be configured only as a cover fixed to the edge portion of the mobile device to cover the display part. In addition, the body 2 may surround only the edge portion of the mobile device, or may surround the edge portion and the rear surface of the mobile device.

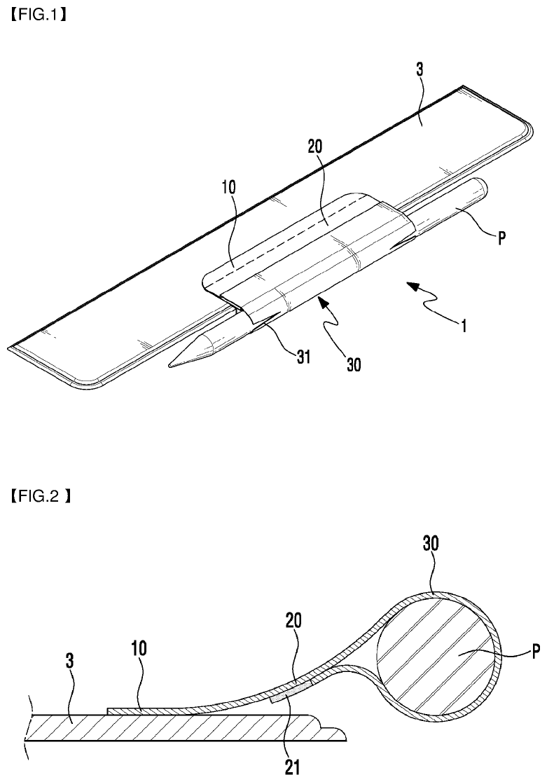

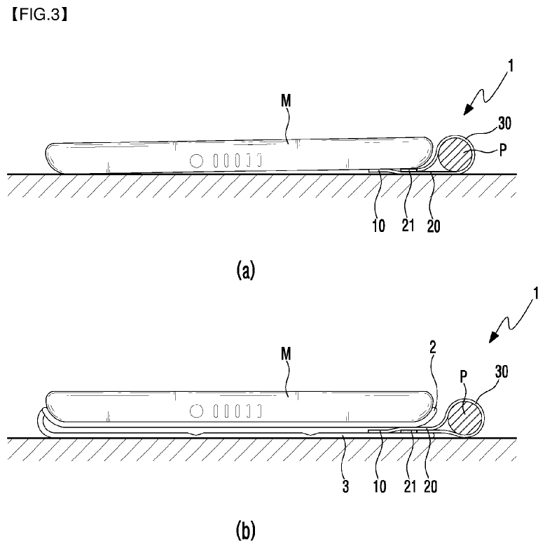

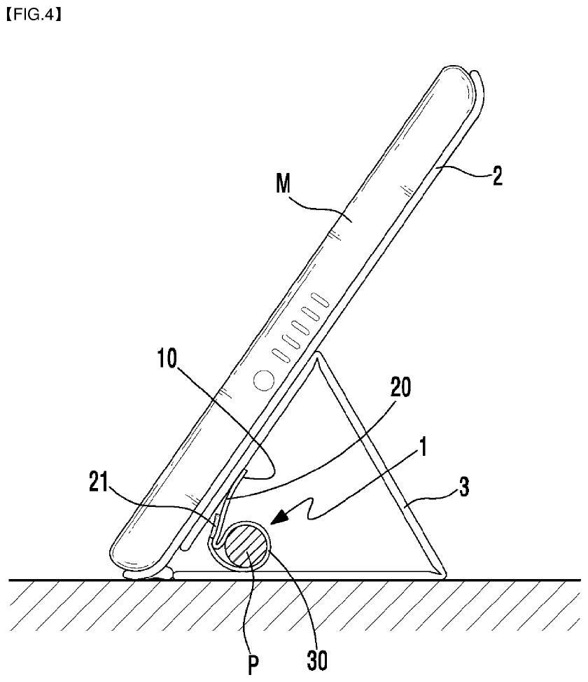

FIG. 1 is a perspective view showing a penholder 1 for a mobile device according to the present invention, and FIG. 2 is a sectional view showing the penholder 1 for the mobile device. In addition, FIG. 3(a) is a side view showing a state where the penholder 1 for the mobile device is fixed to the mobile device, and FIG. 3(b) is a side view showing a state where the penholder 1 for the mobile device is fixed to a mobile device case.

According to the present invention, the penholder 1 for the mobile device may include a fixed part 10, an extending part 20, and a holding part 30.

The fixed part 10 refers to a part that is bonded to a surface of the mobile device or the mobile device case to fix the penholder 1 for the mobile device to the mobile device or the like, and the fixed part 10 may be fixed at a position spaced inward from an edge of the mobile device by a predetermined distance on the surface of the mobile device or the like. The “edge of the mobile device” literally represents the edge of the mobile device when the fixed part 10 is directly fixed to the mobile device, and represents a position overlapping the edge of the mobile device in the mobile device case when the fixed part 10 is fixed to the mobile device case.

The fixed part 10 may be fixed to the mobile device by a magnet, a double-sided tape, or the like, and may be fixed to the mobile device case by a magnet, an adhesive, a double-sided tape, sewing, or the like.

The extending part 20 may extend from a side of the fixed part 10, which faces toward the edge of the mobile device, beyond the edge of the mobile device. In addition, the extending part 20 may be foldable with respect to the fixed part 10, so that the extending part 20 may have various angles with respect to the surface of the mobile device or the like.

The holding part 30 may be coupled to an opposite end of the extending part 20, and a touch pen P for the mobile device may be inserted into the holding part 30, so that the touch pen P may be stored together with the mobile device. The holding part 30 may be have, for example, a ring shape that has an inner space having a size corresponding to a cross section of the touch pen P, so that the touch pen P may be inserted into the holding part 30.

According to the penholder 1 for the mobile device of the present invention, the holding part 30 into which the touch pen P is inserted is disposed outward of the edge of the mobile device, so that a mobile device M may be prevented from being tilted due to a diameter of the touch pen P without being located in parallel with a floor surface when the mobile device M is placed on the floor surface for use as shown in FIG. 3. For reference, when the mobile device M is not used, the cover 3 may be located on an opposite side of the body 2 with respect to the mobile device M to protect a display part of the mobile device M. In FIG. 3(b), however, in order to use the mobile device, the cover 3 is rotated to overlap the body 2 so that the display part of the mobile device may be exposed.

In addition, the fixed part 10 may be fixed at the position spaced inward from the edge of the mobile device, and the extending part 20 may be foldable with respect to the fixed part 10. Therefore, as shown in FIG. 4, when the mobile device M is used while standing at a predetermined angle with respect to the floor surface by folding the cover 3 of the mobile device case multiple times such that the cover 3 may have a shape of a three-dimensional figure, and allowing the cover 3 having the shape of the three-dimensional figure to support the mobile device M, the extending part 20 and the holding part 30 may be located inside the three-dimensional figure, so that the cover 3 may be configured in the form of a stable three-dimensional figure.

The fixed part 10, the extending part 20, and the holding part 30 may be formed as separate members and connected to each other, or may be integrally formed by using a single flexible and thin member such as natural leather, synthetic leather, synthetic rubber, or fabric.

When the penholder 1 for the mobile device is formed by using a member of a flexible material, the holding part 30 may be formed by folding and attaching an end of the flexible material member, or perforating a hole to the flexible material member. The member of the flexible material may be configured in one layer or multiple layers.

The extending part 20 preferably includes a first magnet 21.

A metal or magnet may be provided at the edge portion of the mobile device, and the mobile device case may include a magnet that may be attached to the edge portion of the mobile device such that the cover 3 may be maintained in close contact with the display part of the mobile device M when the mobile device is not in use. The first magnet 21 of the extending part 20 may allow the extending part 20 to be attached to the surface of the mobile device or the like without rotating about the fixed part 10. In other words, an attractive force may act between the first magnet 21 of the extending part 20 and the magnet of the mobile device or the like.

The extending part 20 including the first magnet 21 may be attached to the surface of the mobile device or the like when the mobile device is not in use, so that the extending part 20 and the holding part 30 may be prevented from being damaged by other objects while moving. In addition, in a case where the penholder 1 for the mobile device is applied to the mobile device case, when the mobile device is used while standing as shown in FIG. 4, the extending part 20 including the first magnet 21 may be detached from the surface of the mobile device case so that the extending part 20 and the holding part 30 may be prevented from interfering with an operation of forming a three-dimensional figure by using the cover 3 of the mobile device case.

The first magnet 21 is preferably disposed in the extending part 20 at a portion located inward of the edge of the mobile device so as to overlap the mobile device or the like, so that an attractive force may act effectively between the first magnet 21 and the magnet provided in the mobile device or the like.

A plurality of magnets may be embedded in the edge portion of the mobile device. In this case, adjacent magnets may be arranged such that opposite poles of the adjacent magnets face toward the surface of the mobile device, that is, when one magnet has an N-pole facing inward of the mobile device and an S-pole facing toward the surface of the mobile device, an adjacent magnet may have an S-pole facing inward of the mobile device and an N-pole facing toward the surface of the mobile device. In addition, a plurality of magnets may be mounted in the mobile device case for such a mobile device, and the adjacent magnets may be arranged such that the opposite poles of the adjacent magnets face toward the surface of the mobile device case, so that an attractive force may be generated between the magnets and the magnet of the mobile device that is disposed at a corresponding position. Therefore, the first magnet 21 of the extending part 20 is preferably provided as described above. In other words, a plurality of first magnets 21 of the extending part 20 may be arranged in a direction parallel to the edge of the mobile device, and the adjacent magnets may be arranged such that the opposite poles of the adjacent magnets face toward the mobile device or the mobile device case. In addition, the first magnets 21 of the extending part 20 may be arranged such that opposite poles of each of the first magnets 21 and a magnet disposed in the mobile device or the like at a position facing each of the first magnets 21 may face each other. Accordingly, an attractive force may act between each magnet of the mobile device and each of the first magnets 21 of the extending part 20.

The magnets embedded in the edge portion of the mobile device may be arranged such that one predetermined pole faces toward the surface of the mobile device, and the magnets of the mobile device case for such a mobile device may also be arranged such that one predetermined pole faces toward the surface of the mobile device case. In this case, the first magnets 21 of the extending part 20 may also be arranged such that one predetermined pole faces toward the mobile device or the mobile device case as described above, so that an attractive force may act between each magnet of the mobile device and each of the first magnets 21 of the extending part 20.

When the extending part 20 includes the first magnet 21, the fixed part 10 may include a second magnet 11 or a metal piece.

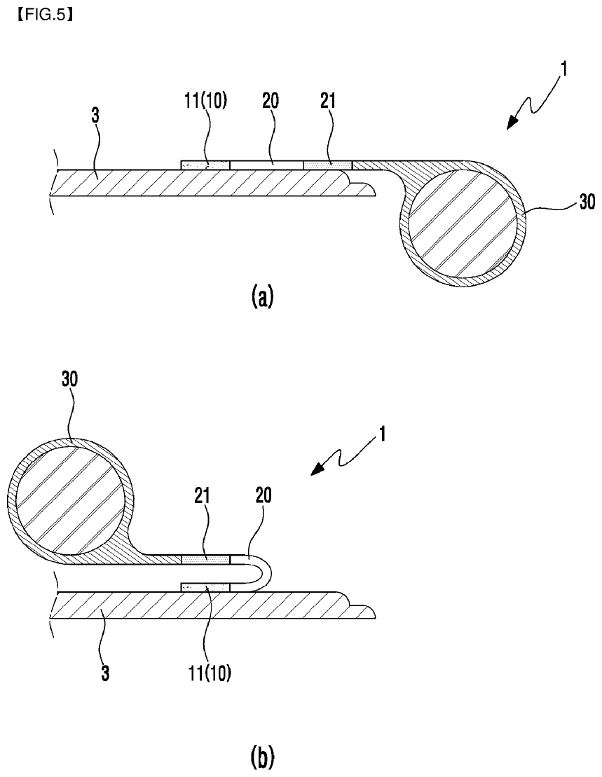

As shown in FIG. 5, the second magnet 11 or the metal piece may generate an attractive force acting with the first magnet 21 provided in the extending part 20, so that the extending part 20 folded with respect to the fixed part 10 may make close contact with the fixed part 10. In a case where the extending part 20 is fixed to the fixed part 10 in a folded state, when the mobile device is used while standing as shown in FIG. 4, the extending part 20 and the holding part 30 may be more reliably prevented from interfering with the three-dimensional figure formed by the cover 3 of the mobile device case.

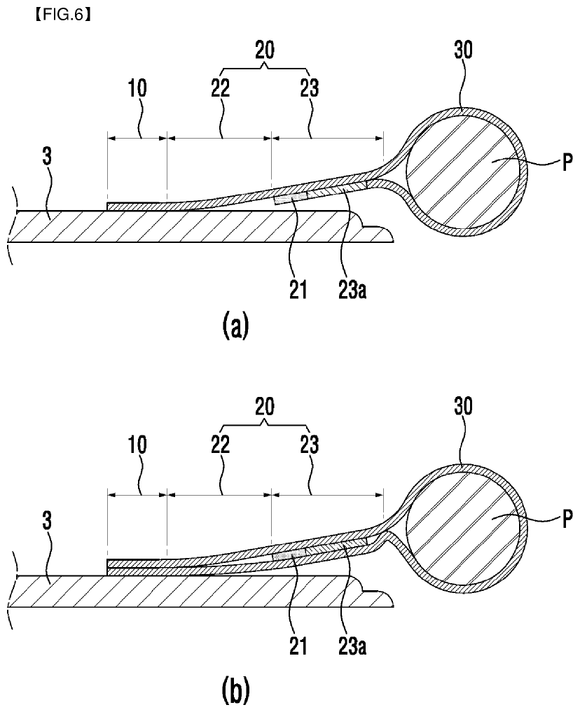

The extending part 20 may include a soft part 22 and a hard part 23. FIG. 6 is a sectional view showing the penholder 1 for the mobile device in such a case.

The soft part 22 may be disposed in the extending part 20 while being adjacent to the fixed part 10, and may be flexible so as to be folded with respect to the fixed part 10. In addition, the hard part 23 may be disposed in the extending part 20 while being adjacent to the holding part 30, and may have rigidity so that a portion of the extending part 20 other than a portion which is necessary to be folded may have a predetermined shape.

The folding of the soft part 22 may be guided by an edge of the hard part 23 adjacent to the soft part 22, so that the soft part 22 may be folded in a predetermined direction, that is, along a line parallel to the edge of the mobile device. In addition, an edge of the hard part 23 adjacent to the holding part 30 may support the holding part 30, and the edge of the hard part 23 adjacent to the soft part 22 may support the soft part 22, so that the extending part 20 or the holding part 30 may be prevented from being deformed and damaged when the touch pen P is inserted into the holding part 30.

The extending part 20 may be provided with the soft part 22 and the hard part 23 as shown in FIG. 6(a) such that the whole of the soft part 22 and the hard part 23 are formed of a flexible material while a hard member 23a having rigidity is attached to a position corresponding to the hard part 23.

In this case, the soft part 22 to which the hard member 23a is not attached may maintain flexible properties, and the hard part 23 to which the hard member 23a is attached may have rigidity.

The hard member 23a may be formed of plastic or a metal, and may be attached to a member formed of a flexible material such as natural leather by using an adhesive or the like, so that the soft part 22 and the hard part 23 may be formed very easily.

In addition, the extending part 20 may be provided with the soft part 22 and the hard part 23 as shown in FIG. 6(b) such that the whole of the soft part 22 and the hard part 23 are configured as a double layer member formed of a flexible material while the hard member 23a having rigidity is embedded between double layers at the position corresponding to the hard part 23.

In this case, similar to the case of FIG. 6(a), the soft part 22 in which the hard member 23a is not embedded may maintain flexible properties, and the hard part 23 in which the hard member 23a is embedded may have rigidity.

Since the embedded hard member 23a is not exposed to an outside, an appearance or a tactile sensation of the penholder for the mobile device may not be deteriorated.

When the extending part 20 includes the soft part 22 and the hard part 23, the hard part 23 may include the first magnet 21.

The first magnet 21 of the hard part 23 may allow an attractive force to act with the magnet of the mobile device or the like, so that the extending part 20 may be attached to the surface of the mobile device or the like without rotating about the fixed part 10.

Since the first magnet 21 has rigidity, it is preferable to form the first magnet 21 in the hard part 23, which also has rigidity, in terms of not damaging the flexible properties of the soft part 22.

In addition, the first magnet 21 is preferably disposed in the hard part 23 at a position adjacent to the soft part 22 so that an attractive force may act effectively between the first magnet 21 and the magnet of the mobile device or the like.

The holding part 30 may have a tube shape having a space into which the touch pen P is inserted.

When the penholder for the mobile device is formed of the member of the flexible material such as natural leather, the holding part 30 may be formed very easily by bending an end of the holding part 30 in a tube shape, and attaching portions where the bending starts and ends to each other with an adhesive or sewing the portions where the bending starts and ends.

The holding part 30 having the tube shape may have a slit 31 formed by removing a portion of a wall of the holding part 30 in at least one of both longitudinal ends of the holding part 30.

The slit 31 may allow an opening of the holding part 30 having the tube shape to be easily spread, and may reduce a friction between an inner peripheral surface of the holding part 30 and the touch pen P so that the touch pen P may be easily inserted into the holding part 30.

The holding part 30 is preferably foldable with respect to the extending part 20.

In this case, the penholder for the mobile device may be configured in a more flexible form, so that when the mobile device M is used, the holding part 30 may be prevented from interfering with the floor surface on which the mobile device M is placed or the cover 3 of the mobile device case.

As described above, the holding part 30 may be formed integrally with other parts of the penholder for the mobile device by using the member of the flexible material such as natural leather, and the holding part 30 formed of a flexible material may be naturally folded with respect to the extending part 20.

Hereinafter, a mobile device case to which the penholder for the mobile device is applied will be described.

The mobile device case according to the present invention may include: a body 2 fixed to an edge portion of a mobile device M; and a cover 3 coupled to one side of the body 2 so as to be foldable with respect to the body 2. The penholder 1 may be fixed to a surface of the mobile device case. In more detail, the penholder 1 may be fixed to the surface of the mobile device case at a position spaced inward from an edge of the mobile device by a predetermined distance.

According to the penholder 1 for the mobile device, the holding part 30 into which the touch pen P is inserted is disposed outward of the edge of the mobile device, and the holding part 30 is foldable with respect to a position which is fixed based on the mobile device case, that is, the fixed part 10, so that the use of the mobile device M may be prevented from being uncomfortable by the penholder for the mobile device when the mobile device M is placed on the floor surface, or when the mobile device M is used while standing at a predetermined angle with respect to the floor surface.

The penholder for the mobile device is preferably fixed to the cover 3 of the mobile device case.

In this case, when the cover 3 is folded in a shape of a three-dimensional figure to support the mobile device at a predetermined angle with respect to the floor surface, the penholder for the mobile device may be located inside the three-dimensional figure, so that the penholder for the mobile device and the mobile device case may be prevented from interfering with each other.

Although it is preferable to allow the body 2 of the mobile device case to surround an entire edge of the mobile device M and a rear surface of the mobile device M in terms of protecting the mobile device M, if the mobile device case and the mobile device M are fixed to each other, the mobile device case may be configured to cover only a portion of the edge of the mobile device.

The scope of the present invention is not limited to the above-described embodiments, and the present invention may be implemented in various other embodiments within the scope of the appended claims. Various changes and modifications made by a person having ordinary skill in the art to which the invention pertains without departing from the gist of the present invention as claimed in the appended claims are construed as being within the scope of the disclosed clams of the present invention.

1. A penholder for a mobile device, in which a touch pen is inserted into the penholder, the penholder comprising:
a fixed part fixed at a position spaced inward from an edge of the mobile device by a predetermined distance;
an extending part extending from a side of the fixed part, which faces toward the edge of the mobile device, beyond the edge of the mobile device, and foldable with respect to the fixed part; and
a holding part coupled to the extending part on an opposite side of the fixed part, and into which the touch pen is inserted.

2. The penholder of claim 1, wherein the extending part includes a first magnet.

3. The penholder of claim 2, wherein the first magnet is disposed in the extending part at a position overlapping the mobile device.

4. The penholder of claim 2, wherein a plurality of first magnets are arranged in a direction parallel to the edge of the mobile device.

5. The penholder of claim 2, wherein the fixed part includes a second magnet or a metal piece.

6. The penholder of claim 1, wherein the extending part includes:
a soft part disposed in the extending part while being adjacent to the fixed part, and having flexibility; and a hard part disposed in the extending part while being adjacent to the holding part, and having rigidity.

7. The penholder of claim 6, wherein the extending part is formed of a flexible material, and
a hard member having rigidity is attached to the hard part.

8. The penholder of claim 6, wherein the extending part includes a double layer formed of a flexible material, and
a hard member having rigidity is embedded in the hard part.

9. The penholder of claim 6, wherein the hard part includes a first magnet.

10. The penholder of claim 1, wherein the holding part has a tube shape having a space into which the touch pen is inserted.

11. The penholder of claim 10, wherein the holding part has a slit formed by removing a portion of a wall of the holding part in at least one of opposite longitudinal ends of the holding part.

12. The penholder of claim 1, wherein the holding part is foldable with respect to the extending part.

13. The penholder of claim 1, wherein the fixed part, the extending part, and the holding part are integrally formed of a flexible material.

14. A mobile device case comprising:
a body fixed to an edge portion of a mobile device; and
a cover coupled to one side of the body so as to be foldable with respect to the body,
wherein the penholder for the mobile device according to any one of claims 1 to 13 is fixed to a surface of the mobile device case.

15. The mobile device case of claim 14, wherein the penholder for the mobile device is fixed to the cover.
